(19) United States
(12) Patent Application Publication
(10) Pub. No.: US 2010/0136709 A1
(43) Pub. Date: Jun. 3, 2010

(54) RECEPTACLE AND METHOD FOR THE DETECTION OF FLUORESCENCE

(76) Inventors: Thomas Ruckstuhl, Wangi (CH); Stefan Seeger, Zollikon (CH)

Correspondence Address: Pabst Patent Group LLP, 1545 PEACHTREE STREET NE, SUITE 320, ATLANTA, GA, 30309, US

(21) Appl. No.: 12/598,397

(22) PCT Filed: Jun. 27, 2008
(86) PCT No.: PCT/EP08/58302

§ 371 Date: Jan. 25, 2010

(51) Int. Cl. G01N 21/62; G01N 21/00

(52) U.S. Cl. 436/164; 422/82.09

(57) ABSTRACT

The invention relates to a liquid receptacle comprising a bottom and sidewalls for holding a liquid. The bottom encompasses a flat sensor surface that is in contact with the liquid when the receptacle is filled, a light-incident area that is located below the sensor surface and is suitable for focusing light onto the sensor surface, a light emergence area, and a cover area that is suitable for reflecting light from the sensor surface such that the light can emerge through the light emergence area. The invention further relates to a method for qualitatively or quantitatively determining an analyte in such a liquid receptacle. In said method, excitation light is focused onto the sensor surface via the light-incident area such that a luminescent marker which characterizes the analyte is excited, and the generated luminescence is then reflected onto the cover surface and is detected after emerging through the light emergence area. The invention also relates to an analysis device comprising a holder for a liquid receptacle, a light source that is disposed such that the light thereof can be focused onto the sensor surface of the liquid receptacle via the light-incident area, and a detector which is arranged in such a way as to be able to detect the light emerging from the light emergence area of the liquid receptacle.

The present invention describes reaction vessels having integrated light collection optics, which may be used for the detection of surface-bound fluorescent molecules. In bioanalytics, a central role is played by solid phase-based assays in which the substances to be detected are increasingly concentrated from the solution by immobilized receptors on the surface. By means of the affinity-based reaction at the surface, the biological substances may be detected in a highly selective way, even in a mixture. Typical receptors are antibodies and DNA-molecules. An example of particularly high relevance is the detection of antigens via highly affine antibodies. Often, the so-called sandwich test is used for a fluorescence-based detection, wherein an intercepting antibody, the receptor, binds the antigen to be detected to the surface. A second fluorescently marked antibody also binds to the antigen and allows the sensitive detection of the complex. The antigen concentration may be quantified by an intensity measurement of the bound fluorescent marker. Due to the high sensitivity that can be achieved, the fluorescence detection is one of the most important detection techniques in biotechnology.

The quantification of small amounts of biological materials places high requirements on the detection technique as regards sensitivity, safety and costs. For the detection of bio markers, which are, for example, generated in conjunction with cancer or cardiovascular diseases, ever lower detection limits are aimed for. For medical applications both robustness and reproducibility of the analysis are of great importance. Moreover, the continuously increasing number of such tests requires measurements involving as little material and time as possible. The signal-to-noise ratio is of central importance for the effectiveness of a sensitive measurement method.

This is particularly true for a fluorescence measurement in which a technological improvement of the ratio of fluorescence intensity and noise results in low detection limits and/or material and time savings. In the detection of binding assays by means of fluorescence methods, the optimisation of the signal-to-noise ratio is done by maximizing the fluorescence collection from the surface-bound molecules while at the same time minimizing the light collection of all sources of interference (noise).

The binding reaction is usually performed at an interface between an aqueous solution and a transparent measurement substrate made of glass or plastic material, which is coated with receptor molecules. An important source of noise is the fluorescence signal of freely diffusing molecules in the assay solution, which may overlap the fluorescence signal of the surface-bound molecules and, thus, renders the determination of the concentration more difficult. This may be avoided by steps of washing which involve time and costs, though. In order to enable a real-time measurement of the binding reaction and to avoid elaborate rinsing (washing) steps, the surface-selective fluorescence detection offers a decisive advantage. Here, it is essential to restrict as far as possible the detection volume to the surface so as to exclude from detection the fluorescence arising from unbound molecules.

The emission of fluorescence requires optical excitation with light of a suitable wavelength. The excitation light induces scattering and also fluorescence in the sample and the substrate. In particular, problems arise from that portion of the light which spectrally overlaps the emission of the fluorescent dye to be detected and which cannot be blocked by means of a wavelength filter. As a significant part of this light is generated in the measurement substrate, suppression of the contribution is performed by reducing the detection volume in the substrate material. This may be effected by a spatial filtering of the fluorescence signal. Here, the circumstance is exploited that fluorescence and scattered light are generated in a spatially separate manner and, thus, may be separated by the optical system. By means of the different optical paths of fluorescence and scattering, the latter may be strongly suppressed in a geometrical way, for example by means of an aperture. In summary, simple design goals result for the detection volume of the fluorescence measurements: firstly, the fluorescence detection of the optical system at the interface should be as high as possible. Secondly, the light collection both within the aqueous sample and within the substrate should be as low as possible.

The closeness of the interface of two dielectric materials, such as between water (refractive index n1≈1.33) and glass (n2≈1.52) has a significant influence upon the properties of the fluorescence emission. In contrast to the fluorescence irradiation within a homogenous medium, the emission of the surface is not isotropic but features a strong maximum in the direction of the critical angle of total reflection α_{c}, wherein

α_{c}=arcsin(n1/n2).

For the water/glass interface α_{c}≈61°. Fluorescent molecules which are bound to the surface irradiate about 74% of the light into the glass. 34% of the total emission is effected above the critical angle α_{c}. The fluorescence emission above the critical angle (supercritical angle fluorescence) is of paramount importance for binding assays. It occurs exclusively by molecules which are located directly in front of the interface, that is in a distance to the substrate that is significantly smaller than the emission wavelength. Consequently, a fluorescence collection restricted exclusively to a region above the critical angle allows a surface selective detection. The contribution of unbound fluorescent dies may, thus, be suppressed almost completely, which allows real-time measurement of binding reactions, for example.

The conventional method of a surface selective fluorescence measurement is performed by means of a so-called evanescent excitation of the interface. Here, the excitation light is incident onto the interface above the critical angle and is totally internally reflected within the measurement substrate. Thus, on the sample side of the interface a thin excitation layer is generated, by which the surface-bound molecules may selectively be excited to fluoresce. This method is, however, technically elaborate and hinders miniaturization.

Ruckstuhl and Seeger describe a method to collect fluorescence emission above the critical angle in a very efficient manner (PCT/EP099/1548). An optical waveguide made of glass or plastic comprises a shell surface (boundary surface) which collimates light by internal reflection. The use of a shell surface having a parabolic shape collimates the fluorescence into a parallel beam (bundle) of rays and facilitates further processing of the signal. The collimated fluorescence may be focussed by an aperture serving as a spatial filter. The aperture reduces the detection volume within the substrate and filters the scattered light/autofluorescence induced by the exciting light therein. Thus, the collimator achieves a very high signal-to-noise ratio and even allows the detection of individual molecules. Even the fluorescence is collected exclusively above the critical angle, the collection efficiency of the collimator is more than 30%, which is significantly higher than the values of common detection systems. Fluorescence sensors based upon fiber optics achieve collection efficiencies around 1%. Refraction-based single lenses may be produced up to a numerical aperture (N.A.) of about 0.6 and at least achieve efficiencies around 5%. Conventional lenses or lens systems, however, predominantly collect fluorescence below the critical angle and, thus, do not allow for a surface selective fluorescence collection.

In the field of bioanalytics, small standardized reaction vessels are also used such as test tubes or cuvettes for single measurements and microtiter plates for measurements with higher throughput. In the microtiter plates a plurality of reaction vessels, so-called wells, are arranged in a grid on a surface of 7×11 cm², which by default allows for 9, 384 or 1526 independent measurements. The wells are usually read out sequentially, requiring a fast displacement of the plate between the measurements. By integrating the collimator for supercritical fluorescence in the micro titer plates, the signal yield may be significantly improved with respect to conventional plates. Moreover, real-time measurements of binding reactions with high throughput are rendered possible. However, to that end the collimator has to be miniaturized down to a few millimetres in diameter.

The excellent light collection capability of the collimator is restricted to a limited region around the optical axis. With increasing distance of the fluorescence emission from the optical axis, quality of light bundling and collection efficiency are deteriorated. This is analogous to fluorescence microscopy in which optics (lenses) of a high numeric aperture achieve a high collection efficiency and sensitivity, but only within a relatively small region in the object space. In order to fully exploit the performance of the collimator, the exciting light has to be bundled on the surface around the optical axis of the collimator. The size of the useful area and the precision with which the exciting light has to be centered onto the optical axis depend upon the size of the collimator. A miniaturization of the collimator leads to a reduction of the useful surface and, thus, increases precision requirements. This increases the requirements and costs of the motorized displacement means, leads to an increased time requirement and may have a negative influence on the robustness and reproducibility of the measurements.

The present invention concerns methods of fluorescence collection above the critical angle in cost-effective liquid containers, such as test tubes and microtiter plates made of plastic. This is achieved by means of a novel collimator and by integrating the element into the receptacle bottom (floor). An improvement is constituted in particular be the integration of the focussing optics for the excitation light into the base of the receptacle. By means of a convex surface arranged below the interface between analyte and receptacle bottom the exciting light may be focussed onto the interface in vicinity of the optical axis of the collimator. This results in a significant increase in the allowed tolerances when centering the exciting light onto the optical axis of the collimator. It results, inter alia, in the advantage that in a sequential readout of several reactions the displacement of the receptacles above the detection system may be smaller and may be effected with a lower precision without negative effects on the sensitivity or the reproducibility of the measurements. The manual or automatized change of the receptacles in between two measurements may, thereby occur faster and/or be realized with cheaper components.

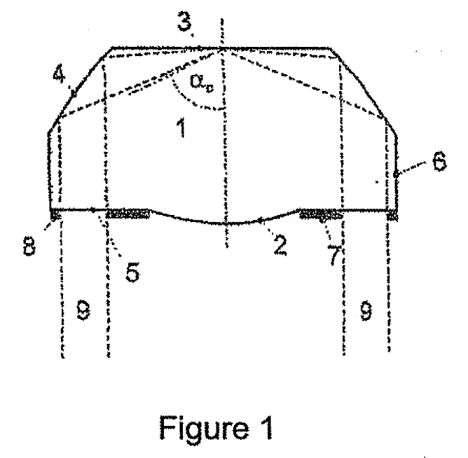

FIG. 1 shows an embodiment of the invention. The illustrated collimator 1 forms part of a liquid receptacle. In order to focus the excitation light, a convexly shaped surface 2 is integrated at the lower side of the collimator 1. The convex surface 2 is preferably arranged in a rotationally symmetric manner around the optical axis of the collimator and focuses the light preferably close to the axis onto the opposite sensor surface 3 which is in contact with the liquid analyte. For binding assays the sensor surface 3 may be coated with receptor molecules. The fluorescence emitted at large angles into the waveguide material is reflected by the shell surface of the collimator 4 and exits the collimator through the light exit surface 5 at the lower side. The collimation by the shell surface may be due to total internal reflection if it is surrounded by a medium having a refractive index smaller than 1.1, such as for example air having a refractive index of 1.0. The shell surface may, however, be metalized as well. The shell surface is preferably convexly shaped so that the fluorescence, after emerging from the collimator, rums bundled around the optical axis 9. The use of a parabolic shell surface is especially advantageous as the fluorescence may thereby be collimated to an almost parallel beam of rays. The shell surface 4 may directly adjoin the light exit face 5, but may also be adjoin a further surface 6 which may be used in order to support the member, for example. The opaque aperture 7 may avoid that excitation light enters into the collimator 1 outside of the light entrance face 2. Moreover, by choosing the outer diameter of aperture 7, the angle range of the fluorescence collection may be limited upwards. The angle range of the fluorescent light collection may be limited downward by an opaque aperture 8 so as to lie preferably above the critical angle α_{c}. The angle range of the light collection may, however, be also limited downward without any aperture 8, that is by appropriately choosing the outer diameter of the shell surface 4. The region of the sensor surface 3 is flat at least in that region that is excited by the light source. Preferably, the flat region has a diameter of more than 100 micrometers. The size of the collimator is preferably adapted to the respective size of the analyte receptacle. Common diameters range between 2 and 15 millimetres. If a parabolic shell surface 4 is chosen, its focal distance lies preferably in the range of 0.4 to 3 millimetres. The focal point of the parabolic shell surface is then preferably situated on the sensor surface so that the fluorescence incident upon the shell surface is collimated into a largely parallel beam of rays. The distance of the convex light entrance face to the sensor surface is preferably 2 millimetres to 20 millimetres. The diameter of the light entrance face 2 is usually smaller than the inner diameter of the shell surface 4 and is preferably in the range of 0.5 to 6 millimetres. For a cost effective mass production of the collimator, injection moldable optical grade plastics such as PMMA, PC, PS, Zeonor or Zeonex are particularly suitable.

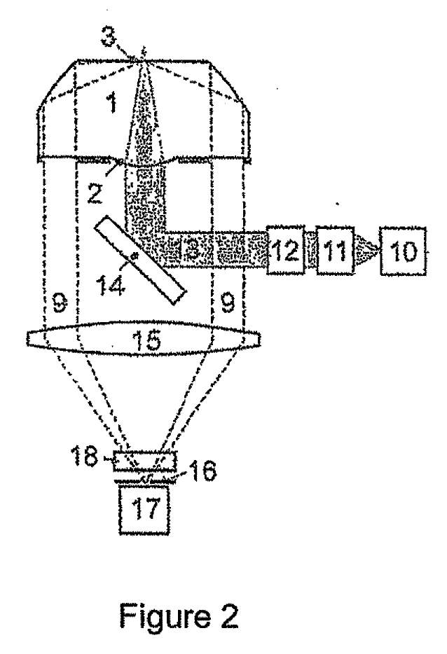

FIG. 2 shows a possible embodiment of the analysis device for measuring fluorescence having a collimator 1 integrated in the receptacle base. A light source 10 emits light of a suitable wavelength for exciting fluorescence. The light is sufficiently collimated by optical components 11 and is brought to a suitable beam diameter. These components may include optical lenses, optical fibres, mirrors and apertures. The light is spectrally filtered by wavelength filter 12. The excitation light is irradiated into the collimator in the direction of the optical axis. The fluorescence emitted above the critical angle exits the collimator in a ring-shaped manner as bundled radiation. However, the collimator collects also fluorescence from the convex face 2. The fluorescence in this angle range around the optical axis may also be emitted by molecules not bound to the interface 3. Therefore, for a surface selective measurement the fluorescence collected from the convex face 2 has to be completely blocked. To that end, a reflector member 14 is disposed beneath the collimator, which separates fluorescence emitted in the vicinity of the axis from the supra critical fluorescence. In the illustrated case, the reflector member 14 directs the exciting light 13 onto the optical axis of the collimator and, at the same time, completely reflects the fluorescence collected by the convex face 2 out of the detection beam path. In a further embodiment the reflector element may be configured so as to reflect the supra-critically emitted fluorescence while letting excitation light and fluorescence collected in the vicinity of the axis pass through. In the detection beam path, optical components 15 are disposed which focus the supra-critical fluorescence through an aperture 16 and project it onto the light sensitive surface of a detector 17. The aperture serves for spatial filtering and is arranged so that scattered light or autofluorescence generated in the collimator is largely blocked while letting fluorescence from the surface pass through. Preferably, wavelength filters are included in the detection beam path.

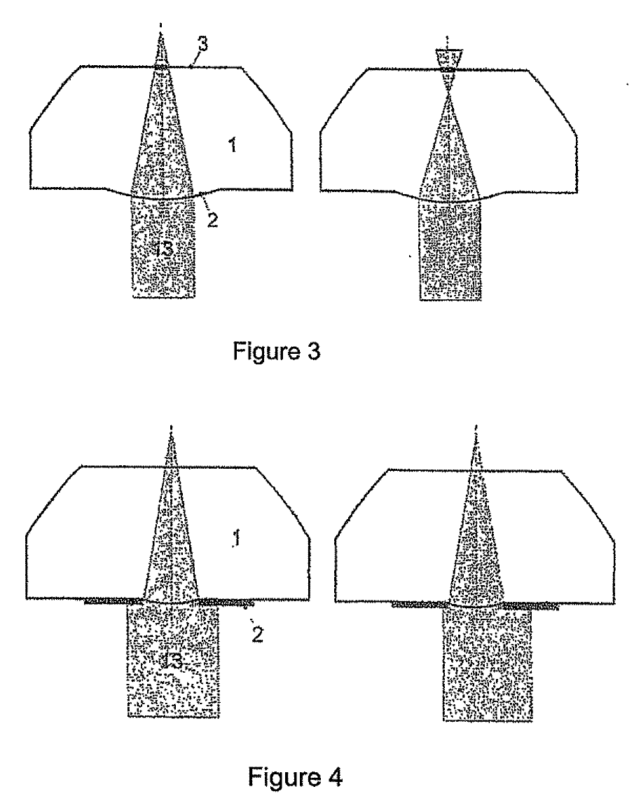

In an embodiment of the invention, the convex face 2 has an aspherical shape. The curvature of the surface may be chosen so that the excitation light is diffraction-limitedly focussed within the waveguide material. As shown in FIG. 3, the focal length of the aspherical body is chosen so that the focus is situated below or above the sensor surface 3. In this way, an excitation disk having a defined diameter may be produced on the interface, preferably having a diameter of less than 300 micrometers.

In an embodiment of the invention, the diameter of the convex face 2 is chosen smaller than the cross section of the collimated excitation beam 13 (FIG. 4). The part of the excitation beam incident onto the collimator outside of the convex face is blocked at the collimator by the opaque aperture 7. If the excitation beam has a homogeneous intensity profile, that is a constant intensity across the entire cross-section, a certain lateral displacement between the optical axis of the collimator and the excitation beam does not have any influence onto the excitation profile of the sensor surface 3. Thereby, the fluorescence bound at the surface of the collimator may be reproducibly read out without the need for a highly precise lateral adjustment of the collimator. This is of particular advantage for the fast sequential readout of several collimators. The sensor surface 3 is preferably excited in a region around the optical axis, preferably this region has a diameter of less than 300 micrometers. Smaller collimators of few millimetres in diameter require a still more precise centering of the excitation light on the optical axis, however. By integrating the convex face 2 into the bottom of the receptacle, the excitation light incident onto the sensor surface may be precisely centered onto the optical axis, even with a lateral displacement of the collimated excitation beam 13 with respect to the optical axis of the collimator of several 100 micrometers.

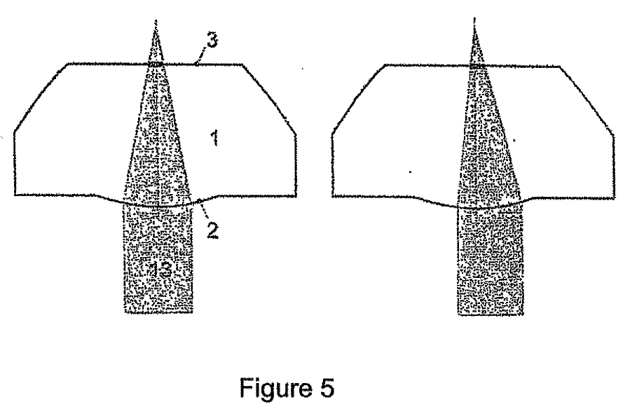

In an embodiment of the invention, the diameter of the convex face 2 is larger than the cross section of the collimated excitation beam (FIG. 5). Even with a certain lateral displacement of collimator and excitation beam, the light hits the sensor surface 3 of the collimator in a very axially centred manner.

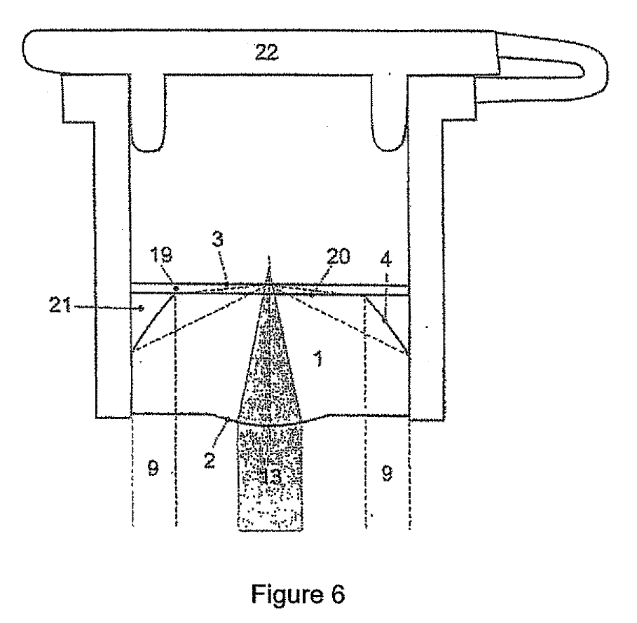

In an embodiment of the invention, a transparent, preferably flat (planar) substrate made of plastic or glass, for instance a microscopy cover glass, is integrated into the receptacle bottom. This is shown in FIG. 6. The substrate 19 may be bonded to the collimator by an optical adhesive 20. The substrate, the optical adhesive and the collimator preferably have similar indices of refraction. The arrangement is chosen so that fluorescence is excited and collected at the upper side of the substrate, that is the sensor surface 3 lies on the substrate. The use of a flat substrate has the following advantages: firstly, the microscopy cover glass allows fluorescence measurements having a very small background. Secondly, such glasses are mass produced and are very cheap. Thirdly, the substrate avoids contact of the aqueous sample with the shell surface 4. A gaseous environment 21 of the shell surface allows a loss-free collimation due to total internal reflection. Fourthly, glass is particularly well-suited for immobilizing receptor molecules. In the illustrated example, the collimator is integrated within a test tube 22.

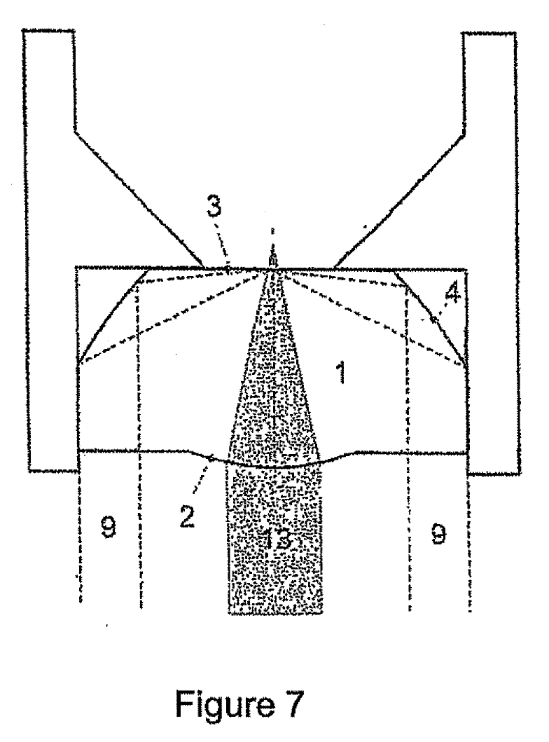

A further embodiment of the invention is shown in FIG. 7. Here, the liquid receptacle consists merely of two components, a receptacle wall and a collimator acting as receptacle bottom. The receptacle wall is configured so as to adjoin the sensor surface 3. In this way, contact of analyte liquid and shell surface can be avoided. Preferably, the receptacle wall may laterally surround the collimator. Thereby, the optical shell surface 4 is protected from contamination, for example finger prints of the user. Also, by using a opaque receptacle wall, one may avoid that ambient light enters the collimator through the shell surface. Advantages of this configuration are in particular lower manufacturing costs and a lower number of glued surfaces which may be sources for quality variations.

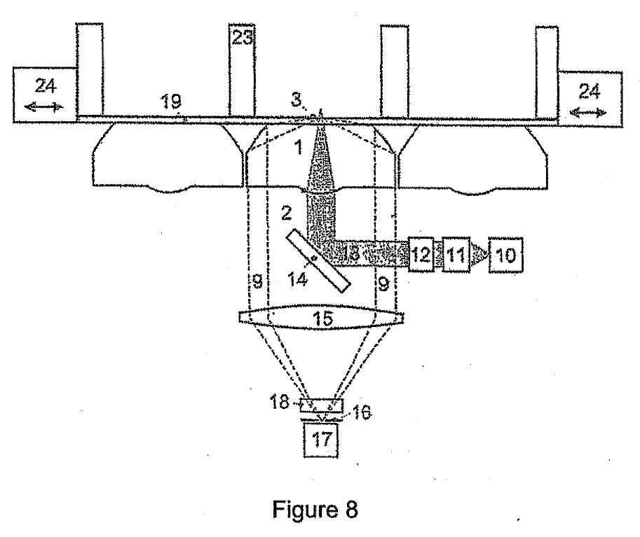

In an embodiment of the invention, the flat substrate is the bottom of a microliter plate through which the fluorescence is detected (FIG. 8). The wells are provided with collimators at the bottom side. The collimators may be individually connected with the bottom of the microtiter plate or may be integrated on an optical element which comprises a plurality of collimators arranged in a plane. The collimators may have the grid distance of the wells, but may also be disposed more densely, which allows measurements at a plurality of locations of a well. The read-out of the collimators is performed sequentially, for example by means of a displacement unit 24 that moves the microtiter plate with the collimators perpendicular to the optical axis. Alternatively, the excitation beam may be translated.

1. Liquid receptacle comprising a bottom and sidewalls for holding a liquid, wherein the bottom comprises:
a) a flat sensor surface that is in contact with the liquid when the receptacle is filled;
b) a light entrance face that is located below the sensor surface and is suitable for focussing light onto the sensor surface;
c) a light exit face;
d) and a shell surface that is suitable for reflecting light from the sensor surface such that the light can emerge through the light exit face.

2. Method for qualitatively or quantitatively determining an analyte in a liquid receptacle according to claim 1, wherein excitation light is focused onto the sensor surface via the light entrance face, thereby exciting a luminescent marker characterizing the analyte, and the generated luminescence is reflected at the shell surface and is detected after emerging through the light exit area.

3. Analysis device, comprising:
a) a holder for a liquid receptacle according to claim 1;
b) a light source that is disposed such that the light thereof can be focused on the sensor surface of the liquid receptacle via the light entrance face; and
c) a detector which is arranged in such a way as to be able to detect the light emerging from the light exit face of the liquid receptacle.

4. (canceled)

5. Liquid receptacle according to claim 1, wherein the light entrance face has a convex shape.

6. Liquid receptacle according to claim 1, wherein the light entrance face has an aspherical shape.

7. Liquid receptacle according to claim 1, wherein the light entrance face has a spherical shape.

8. Liquid receptacle according to claim 1, wherein the light entrance face has a cylindrical shape.

9. Liquid receptacle according to claim 1, wherein the light entrance face is a Fresnel lens.

10. Liquid receptacle according to claim 1, wherein a diffractive structure on the light entrance face is adapted to focus light onto the sensor surface.

11. Liquid receptacle according to claim 1, wherein an opaque aperture is integrated in the bottom, by means of which the entrance of light around the light entrance face may be laterally limited.

12. Liquid receptacle according to claim 1, further comprising recesses at the outer side, which are suitable for fixing the liquid receptacle in the analysis device.

13. Liquid receptacle according to claim 1, further comprising protruding structures at the outer side, which are suitable for fixing the liquid receptacle in the analysis device.

14. Liquid receptacle according to claim 1, wherein the bottom is glued into the receptacle.

15. Liquid receptacle according to claim 1, wherein the bottom is inserted into the receptacle without glue.

16. Liquid receptacle according to claim 1, wherein a transparent flat substrate is integrated in the bottom.

17. Liquid receptacle according to claim 1, which is used as test tube.

18. Liquid receptacle according to claim 1, which is used as microfluidic chip.

19. Plurality of liquid receptacles according to claim 1, which are arranged in a plane.

20. Arrangement of liquid receptacles according to claim 1, which are recesses in a micro titer plate.

21. Method for determining an analyte according to claim 2, wherein the excitation light completely illuminates the light entrance face and the example of light is laterally limited by the opaque aperture.

22. Method for determining an analyte according to claim 2, wherein the excitation light is completely guided to the light entrance face.

23. Method for determining an analyte according to claim 2, wherein light emitted from the sensor surface exclusively above the critical angle passes through the light exit surface.

24. Analysis device according to claim 3, wherein a scanning device allows displacement of the liquid receptacle.
